(19) United States
(12) Patent Application Publication
(10) Pub. No.: US 2006/0147097 A1
(43) Pub. Date: Jul. 6, 2006

(54) Method for reconstructing an image from a set of projections by applying a wavelet transform

(75) Inventors: Pierre Grangeat, Saint-Ismier (FR); Thomas Rodet, Palaiseau (FR); Laurent Desbat, Grenoble (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 10/530,854

(22) PCT Filed: Oct. 14, 2003
(86) PCT No.: PCT/FR03/50089

§ 371 Date: Mar. 9, 2006

(30) Foreign Application Priority Data
Oct. 17, 2002 (FR) 02/12925

(51) Int. Cl. G06K 9/00

(52) U.S. Cl. 382/128

(57) ABSTRACT

A calculation for reconstructing tomographic images involves the decomposition of two-dimensional sets of projections of this image by a wavelet decomposition method, in which the set of projections is separated into thumbnail images expressing the whole and the higher frequency details of the projections, respectively. The reconstruction is carried out separately on the thumbnail images before making a combination. Certain properties of this decomposition, notably in the Fourier frequency domain, provide substantial reduction of the amount of calculations.

The subject of this invention is a method for reconstructing. an image from sets of projections of this image, and by applying a wavelet transform.

Tomographic methods consist of examining an inanimate object or a living being with a network of mobile detectors which take a series of views by rotating around it. These views are projections of the property with which the image may be expressed (normally absorption of radiation passing through the object or scintillation of a radioactive body ingested by the object), i.e. sums of the property along lines passing through the object and defined by collimation of the detectors. Each detector measures a projection of the image at each view. When a sufficient number of views and projections have been taken, one proceeds with inverting the results in order to obtain the value of the property at each point of the object; this inversion is comparable to the inversion of a large dimension equation system and it may overtly be carried out by algebraic methods, or more frequently by analytical methods by which successive numerical operations are applied to the projections without directly inverting the system. A large number of methods exists, among which the one described in the French Patent 2,615,619 will be mentioned which is the first patent of this research team, and in the more recent French Patent 2,810,141 which has a few similarities with the method which will be described herein. An article of Grass published in Phy. Med. Biol., Vol. 45, p. 329, February 2000 may also be mentioned. These operations result in what is called the back-projection of the measurement, i.e. in calculating the value of the property taken at each of the points of the line of the projection.

It may be advantageous to work with results expressed in the Fourier frequency domain, as evidenced in the second document. Numerical transforms of another nature have also been used.

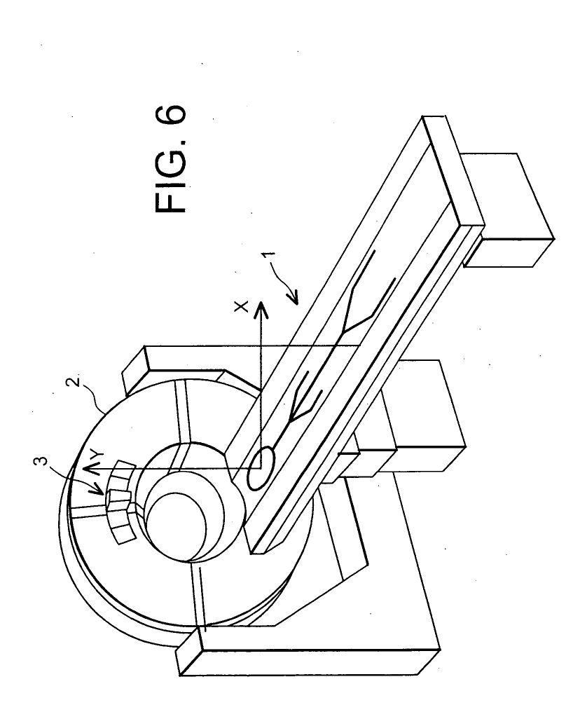

Reference will be made to FIGS. 6, 7 and 8 for a practical and schematic description of a method for taking tomographic measurements. A radiation source F and a detection system III are mobile along an annular frame 2 at diametrically opposite positions, and conical radiation originating from the source F reaches the detection system 3 after having passed through the object 1 to be investigated. The essential part of the detection system 3 is a two-dimensional network 4 of detectors 5. Projections R of the three-dimensional image of the object 1 are measured by those of the detectors 5 which are included within a perimeter 15 of the “shadow” of the object 1. A large number of views of this type are taken at as many different orientation angles θ of the network 4 of the detectors 5. Frequently, an imaginary network 4′ of detectors 5′ is considered on a detection plane Pdet which is parallel to the real network 4 and passes through the center 0 of the frame 2. Coordinates p and q are defined for identifying the detectors 13 from their lines and their columns. Rearrangement calculations, current in the art, enable measurements of any network 4 to be transposed to the imaginary network 4′ and reconstruction algorithms may be applied to the latter.

French Patent 2,615,619 will be recalled here as it explained the numerical operations in detail, notably those so-called filtering and back-projection operations allowing the image of the object to be obtained from its projections; however various methods exist.

The problem tackled here is reducing the time and the volume of the calculation for inverting the system of measurements.

It is known that this is one of the most serious limitations in tomographic methods, and many new methods have been designed for the same purpose as the invention, including the one of the second cited patent.

The idea expounded here is to utilize the particular properties of a numerical transform, a so-called wavelet decomposition, of projections for obtaining locations of negligible or insignificant projections and not to apply the inversion calculations to these locations. Enhancements further provide a larger reduction of the calculations.

In its most general form, the invention is related to a method for reconstructing an image from sets of projections of this image, successively comprising:

a series of successive decomposition of sets of wavelet projections providing thumbnail images of the sets of the projections, comprising images of an approximation (AA) and successive series (Dd, Dh, Dv) of homologous details of each set,

in each of the series and successively for thumbnail images of details having an increasing number of points, a search for insignificant portions estimated to be lacking in content, and a search for homothetic portions of insignificant portions in each of the thumbnail images of details which follow in the series;

back-projections of thumbnail images of the thumbnail projection sets of the image to be reconstructed, with omission of back-projections for all the insignificant portions and all the homothetic portions,

and a combination of thumbnail images to be reconstructed by a decomposition inversion providing said image.

The order of the steps (especially the back-projections preceding the recomposition) is essential for obtaining the advantages of the invention.

The prior art comprises an example for reconstructing an image by wavelet decomposition (U.S. Pat. No. 5,953,388), which however is applied therein for reconstructing only a portion of the image, by utilizing the “locality” property of the decomposition, which is hardly sensitive to the other portions of the image, which may thereby be neglected in the calculations. Patent U.S. Pat. No. 5,841,890 deals with an analogous subject and considers various aspects of the wavelet decomposition applied to tomography. Decomposition is not used for accelerating back-projection calculations in order to obtain an overall image, more sparingly in calculations.

Finally, document U.S. Pat. No. 6,148,110 should be mentioned, which describes a method with numerical masks like the one of the invention, but only for compressing an image signal without calculating any back-projection.

The invention will now be described more practically and completely in connection with the following figures:

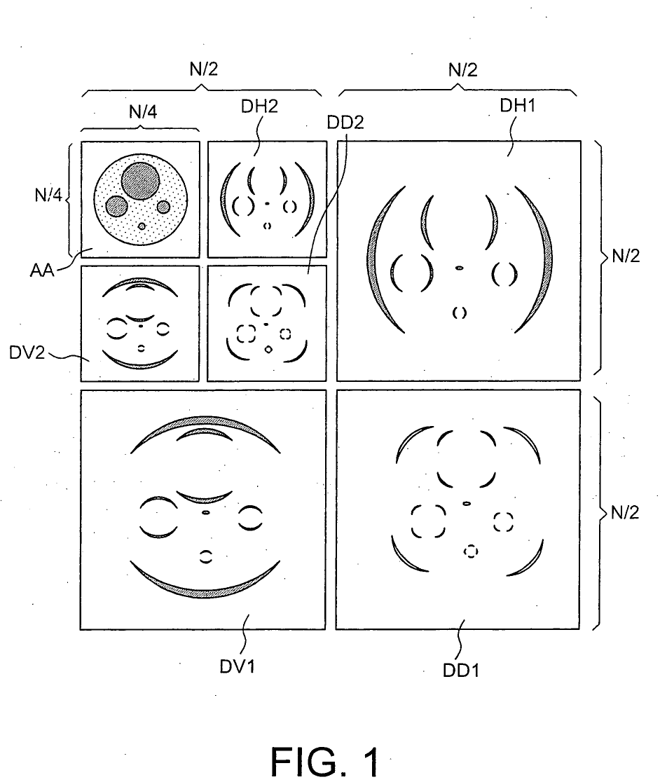

FIG. 1 illustrates a wavelet decomposition of an image,

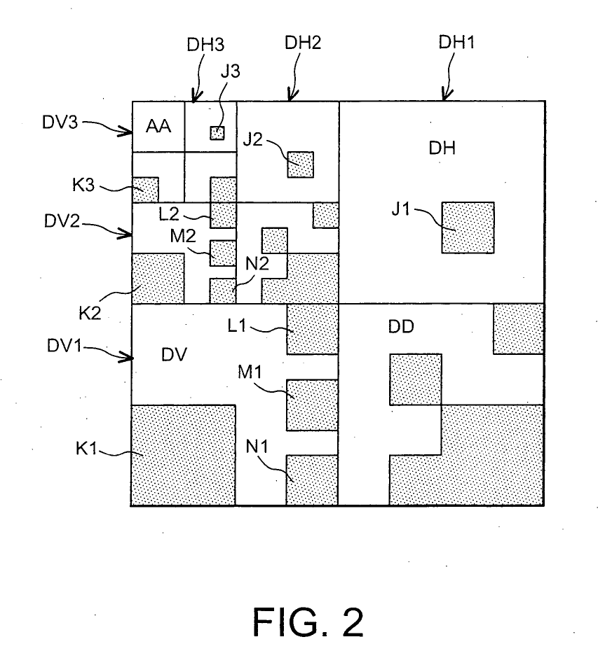

FIGS. 2, 3 and 4 illustrate certain aspects of the invention,

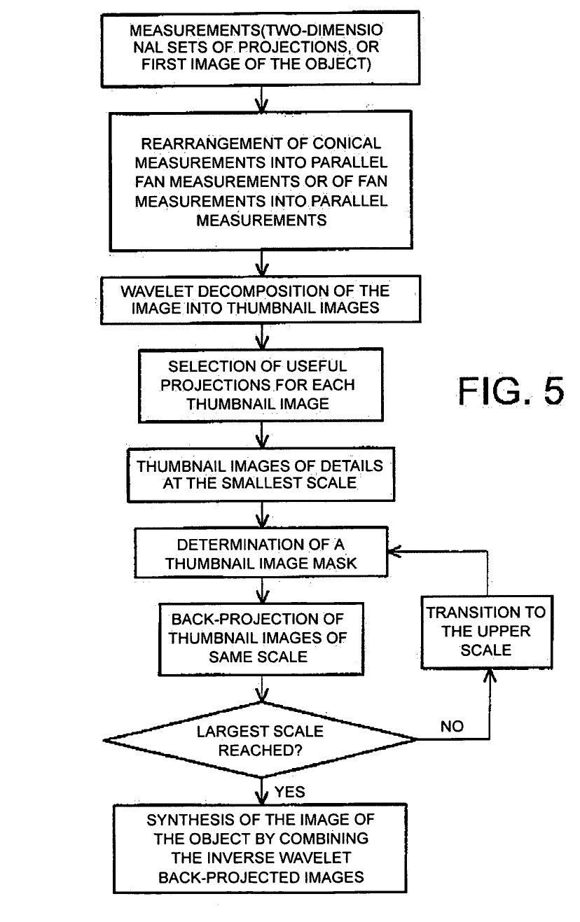

FIG. 5 illustrates a flow chart summarizing a complete embodiment of the method,

FIG. 6 illustrates a basic device of the method,

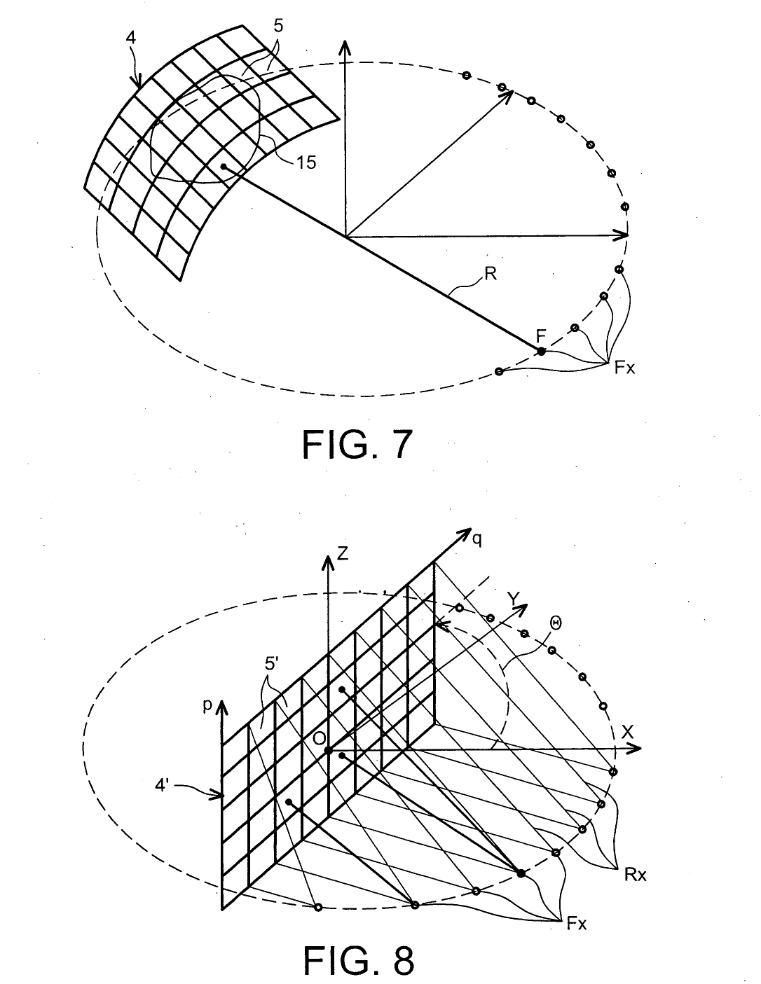

and FIGS. 7 and 8 illustrate in more detail the method and certain rotations used.

We shall begin by discussing the transformation of a signal by a wavelet decomposition. Several models of wavelets exist, which have in common the fact of being comparable to a lowpass filter. The signal is separated into two portions, one of which, associated with low frequencies, may be considered as an approximation of the signal, whereas the other one associated with high frequencies rather expresses its details. A property of the wavelets is that the portions may each contain one half of the points of the signal to such an extent that there is no loss of information through this decomposition. The decomposition may be made in the direct domain of expression of the signal or in the Fourier domain.

In the case of projections of an object examined on a generally two-dimensional network of detectors, the projections may be grouped into two-dimensional sets according to two of their coordinates (generally p and q on the axes of a network of detectors). However, as illustrated by FIG. 8, sets of projections rearranged on an imaginary network of detectors are most frequently considered. In the example of FIG. 8, projections Rx originating from a certain number of successive positions Fx of the radiation source F are grouped so that the projections resulting in a same column (at constant q) of detectors 5′ of the imaginary network 4′, originate from a same position Fx, and also that the planes of projections are all parallel up to the positions Fx: the problem of a conical geometry of the radiation has then been transformed into a parallel fan geometry which is more simple to solve. Moreover, the imaginary network 4′ passes through the centre O of rotation and therefore belongs to the detection plane Pdet, which also facilitates the calculations.

The invention may further be applied to reconstructions of sections through the object 1 by means of a one-dimensional network of detectors (all at the same coordinate p). The principle discussed above of rearranging the projection of planar fan geometry into a parallel geometry may also be applied.

The processing of the rearranged measurements is done by following the lines of detectors 5 of the imaginary network 4′, successively for all the points.

A signal may successively be decomposed into wavelets in order to provide several levels of results. The new decompositions only relate to the portion of the wavelet which gave the approximation of the signal, the portion(s) which provide the details, are retained.

Let us take as an example of a wavelet decomposition object, an image formed of five circles including an external circle and four circles with different diameters, all inscribed within the first one. The initial image comprised n×n points and if a wavelet decomposition of this image is applied twice according to the principle above, the result is given in FIG. 1.

The decomposition of the image into wavelets gives a set of thumbnail images, three of which are larger than the other ones, each comprising n/2×n/2 points, and corresponding to the horizontal details, to the diagonal details, and to the vertical details of the large scale initial image; they are marked Dh1, Dd1, and Dv1, respectively. The horizontal details of the image are obtained from the projections of angles θ close to 0 or π, the vertical details from the projections of angles θ close to π/2 or 3λ/2, and the diagonal details from the projections of intermediate angles with the conventions of FIG. 1. The remainder of the image consists of four thumbnails each comprising n/4×n/4 points and three of which are thumbnails of horizontal, diagonal and vertical details at a smaller scale, marked as Dh2, Dd2 and Dv2, whereas the last thumbnail is an approximation of the initial image marked as AA. If φ and ψ designate the wavelet decomposition functions of an image or of a thumbnail image, function φ giving the approximation and function ψ the details, the functions to be applied to the initial image for obtaining the decomposition of FIG. 1 are given by Table I.

$$AA : ϕ ( {x}_{1} ) ϕ ( {x}_{2} ) ϕ ( \frac{x 1}{2} ) ϕ ( \frac{x 2}{2} )$$

$$Dv 2 : ϕ ( {x}_{1} ) ϕ ( {x}_{2} ) ϕ ( \frac{x 1}{2} ) Ψ ( \frac{x 2}{2} ) , \\ Dd 2 : ϕ ( {x}_{1} ) ϕ ( {x}_{2} ) Ψ ( \frac{x 1}{2} ) Ψ ( \frac{x 2}{2} ) , \\ Dh 2 : ϕ ( {x}_{1} ) ϕ ( {x}_{2} ) Ψ ( \frac{x 1}{2} ) ϕ ( \frac{x 2}{2} )$$

$$Dv 1 : ϕ ( {x}_{1} ) Ψ ( {x}_{2} )$$

$$Dd 1 : Ψ ( {x}_{1} ) Ψ ( {x}_{2} )$$

$$Dh 1 : Ψ ( {x}_{1} ) ϕ ( {x}_{2} )$$

The invention consists of carrying out the back-projection on each of the thumbnail images of the sets of projections decomposed into wavelets and combining the back-projected thumbnail images by inverting the wavelet configuration in order to obtain the sought-after image. Decomposition into wavelets is favourable to various simplifications which greatly accelerate the calculation. These simplifications are made between the decomposition and the combination.

The first one of them relates to filiations which may be established between homologous details at different scales. For this, series of thumbnail image giving details of the same nature are considered. FIG. 2 (which illustrates a decomposition of an image looking like the one in FIG. 1, but at three decomposition levels) illustrates for the three thumbnail images, horizontal details Dh1, Dh2 and Dh3, homologous portions J1, J2 and J3 which occupy the same position and the same relative surface area on each of these thumbnail images and are thereby inferred from each other by geometrical homothetia in their thumbnail images.

It may be hypothesized that for most of the images encountered in practice (notably with the exception of textured images), if a portion such as J3 has an insignificant content, i.e. which does not reveal anything relatively to the significant values of the thumbnail image, the homologous portions at a larger scale, here J2 and J1, will themselves be also insignificant.

According to the invention, one therefore starts, for the thumbnails of the details, with back-projecting the details at the smallest scale, and then the details at an increasingly larger scale. A numerical threshold is applied to the coefficients of the wavelet, i.e. to the values taken by the transform in the considered thumbnail image. A value less than this threshold gives an insignificant portion, such as J3. However, the insignificant portions of the thumbnail images are not reconstructed, i.e. the back-projection calculations are not performed for them.

Practically, one proceeds with constructing a numerical mask before back-projecting the thumbnail image. On the horizontal details Dh, the mask is constructed for the first time for the thumbnail Dh3. It assumes a value equal to 0 for the insignificant portions such as J3 and equal to 1 elsewhere. The coefficients of the mask follow in a determined order, for example line after line. The back-projection calculations are applied on the thumbnail image, considered in the order of the coefficients of the mask. When a coefficient is equal to 0, no calculation is performed for the corresponding point of the thumbnail image, to which a zero value is assigned in the back-projected thumbnail image.

Upon starting on the following image of the horizontal details (Dh2), with the numerical mask, it is possible not to consider the portion J2, the points of which are not processed by the computing unit which performs the back-projection. If the mask of thumbnail image Dh3, for example, has a zero coefficient at line i and column j, provision is made so that the four points of lines 2i and 2i+1, and columns 2j and 2j+1 of the thumbnail Dh2 will also have insignificant values. The back-projection calculations will not be performed for these points.

A numerical mask is thereby constructed for each decomposition level. The mask describing the thumbnail Dh2 will conventionally comprise coefficients equal to 0 for any portion homologous to a portion with zero coefficients (like J3) of the mask of the corresponding thumbnail image at a smaller scale; in order to determine values 1 or 0 of the other points of the mask of Dh2, comparisons will further be used with the conventional threshold. Other insignificant portions with zero mask values, may appear. This is what has been illustrated in thumbnail images Dv1, Dv2 and Dv3, successive decompositions of vertical details. The thumbnail image Dv3 comprises an insignificant portion K3 for which homologues K2 and K1 are found in the larger scale decompositions. The thumbnail image Dv3 in this example does not comprise any other insignificant portion, but it was possible to find three other ones, marked L2, M2 and N2, on the following thumbnail image Dv2. At the level of a decomposition at a larger scale, that of thumbnail image Dv1, one will not deal with back-projecting the points located at portions L1, M1 and N1, homologues of L2, M2 and N2.

Other particularities of the method of the invention, favourable for accelerating the calculations, will now be examined.

The first one is based on the equality between the Fourier transform of a projection of the image at a set angle and the Fourier transform of the image on a line of same angle passing through the origin.

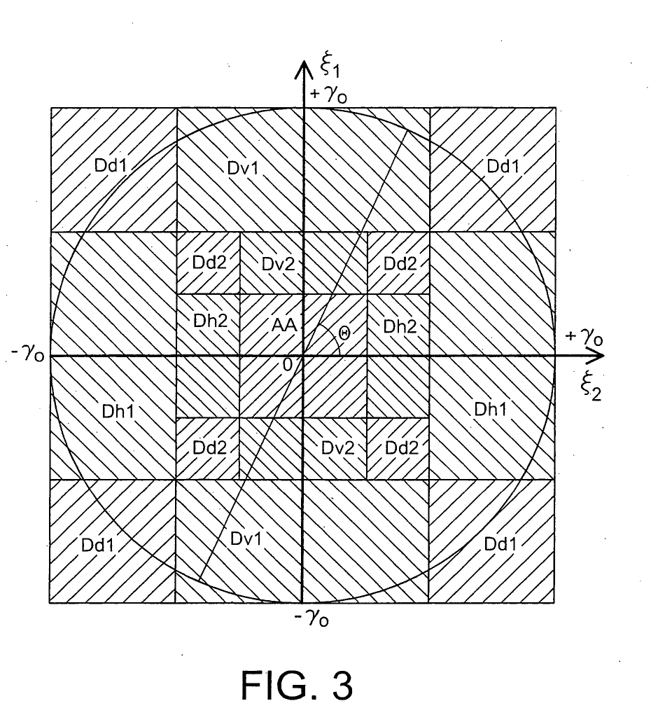

Referring to FIG. 3, where a set of projections has been converted into the Fourier domain in order to provide projections of a frequency nature in the system of axes marked ζ1 and ζ2, the support of the projection set in the Fourier domain comprises values between −v₀ and v₀ for ζ1 as for ζ2. A wavelet decomposition, as that of FIG. 1, causes the approximation still marked as AA in the lower frequencies, to appear around the origin ζ1=ζ2=0, whereas the details are found on either side of this approximation, at increasingly high frequencies for the details at a large scale.

A line passing through the origin is illustrated, forming an angle θ with the horizontal axis ζ1. This line passes through approximation AA, as well as through the thumbnail images of the vertical details Dv1 and Dv2. However, it is ensured that the projections forming this angle θ will be quite unnecessary for the back-projection calculations of the diagonal Dd and horizontal Dh details since the line of angle θ passes at a distance from their thumbnails. The application of the invention then comprises a selection, for each of the thumbnail image categories, of angles of projections which will be used in the calculations. The calculation on the support of the projections is elementary.

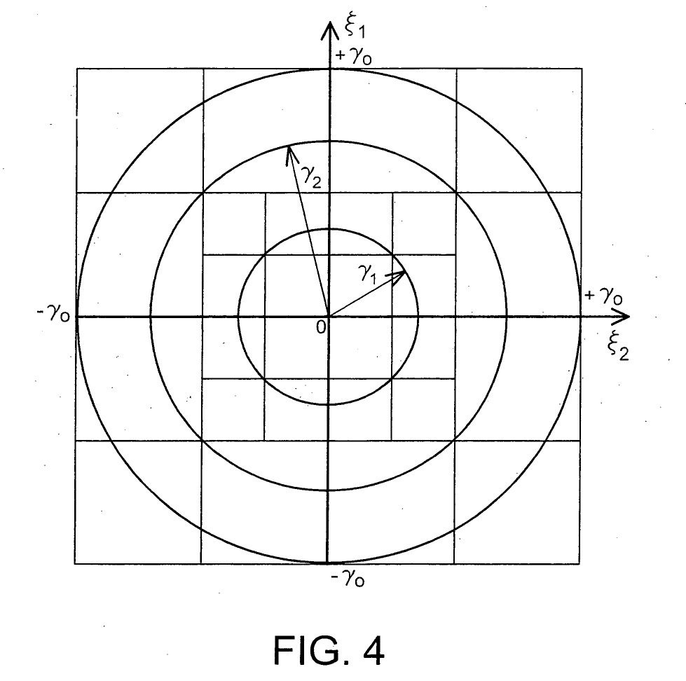

FIG. 4 resumes the division of an image decomposed into wavelets and transposed in the Fourier domain. Perfect reconstruction may be obtained by using a determined number of projections, depending on the reconstruction frequency (discretization) of the image of the object. Thus, in order to reconstruct the approximation AA, it may be shown that it is sufficient to select a number of projections, among those which have been made, corresponding to a maximum frequency v1 being used as a radius to a circle circumscribing the frequency representation of the approximation AA in the decomposition. Also, the smaller scale details will completely be rendered by using a number of projections corresponding to the frequency v2 in the circle having this radius, in the system of axes ζ1, ζ2, and circumscribing the frequency representations of the group of details Dv2, Dd2 and Dh2 at the same scale. With the support of projections in the Fourier domain, it is therefore possible to easily determine the maximum frequencies required for perfect back-projection of the respective thumbnails.

The application of the invention in order to utilize these two features will therefore comprise, upon back-projecting each of the thumbnails, a selection of useful projections for this back-projection, by discarding the other ones; and possibly a restriction on the number of useful projections actually utilized by the calculation so as to keep only a useful number of them.

FIG. 5 is a flowchart of the whole method described herein.

1. A method for reconstructing an image from sets of projections of this image, successively comprising:
a series of successive wavelet decompositions of the sets of projections providing thumbnail images of the sets of the projections, comprising images of an approximation (AA) and successive series (Dd, Dh, Dv) of homologous details of each set,
in each of the series and successively for the thumbnail images of details having an increasing number of points, a search for insignificant portions estimated to be lacking in content, and a search for homothetic portions of the insignificant portions in each of the thumbnail images of details which follow in the series;
back-projections of the thumbnail images of the thumbnail projection sets of the image to be reconstructed, with omission of the back-projections for all the insignificant portions and all the homothetic portions,
and a combination of thumbnail images to be reconstructed by decomposition inversion giving said image.

2. The method for reconstructing an image according to claim 1, characterized in that it comprises a selection of regions of angles (θ) of the sets of projections which are used in the back-projections.

3. The method for reconstructing an image according to claim 2, characterized in that it comprises the selection of a number of projections which are used in the back-projection.

4. The method for reconstructing an image according to claim 2, characterized in that the selection of the angle regions is performed according to a support of a Fourier transform of the wavelet decomposed sets of projections.

5. The method for reconstructing an image according to claim 3, characterized in that the selection of the number of projections is performed according to the maximum frequencies of a support of a Fourier transform of the wavelet decomposed projection sets.
